(19) United States
(12) Patent Application Publication
(10) Pub. No.: US 2025/0080693 A1
(43) Pub. Date: Mar. 6, 2025

(54) VEHICLE WITH INTERIOR/EXTERIOR COMMUNICATION SYSTEM

(71) Applicant: FCA US LLC, Auburn Hills, MI (US)

(72) Inventor: Damodaran Murthy, Troy, MI (US)

(21) Appl. No.: 18/457,400

(22) Filed: Aug. 29, 2023

(51) Int. Cl. H04N 7/14; B60Q 1/50; B60Q 5/00; B60R 1/22; G06F 3/16; H04N 7/18; H04N 23/90; H04R 1/02

(52) U.S. Cl. CPC H04N 7/141; B60Q 1/50; B60Q 5/00; B60R 1/22; G06F 3/162; H04N 7/183; H04N 23/90; H04R 1/028; H04R 2499/13

(57) ABSTRACT

In at least some implementations, a vehicle communication system, includes an interior camera having a field of view that includes at least part of an interior of a vehicle, an exterior display mounted within the interior or on an exterior of the vehicle and oriented for viewing by a person located outside of the vehicle, and a controller coupled to the interior camera and the exterior display to enable selective display of an output from the interior camera on the exterior display to enable said person to be able to view at least part of the interior.

### FIELD

The present disclosure relates to a vehicle having a system for interior/exterior communication.

### BACKGROUND

Occupants within a vehicle sometimes encounter one or more other people who are outside the vehicle. For example, a police officer may approach a vehicle during a traffic stop, and the office has a need to communicate with the driver. A direct person-to-person communication can be stressful with the office closely watching movements of the occupant, and the occupant fearing police action. Of course, people other than officers may also approach or be near a vehicle. Improved communication between vehicle occupants and people outside the vehicle is needed.

### SUMMARY

In at least some implementations, a vehicle communication system, includes an interior camera having a field of view that includes at least part of an interior of a vehicle, an exterior display mounted within the interior or on an exterior of the vehicle and oriented for viewing by a person located outside of the vehicle, and a controller coupled to the interior camera and the exterior display to enable selective display of an output from the interior camera on the exterior display to enable said person to be able to view at least part of the interior.

In at least some implementations, the system includes an interior display arranged for viewing by an occupant of the vehicle, and an exterior camera having a field of view that includes at least a portion of an area outside of the vehicle, and wherein the controller is coupled to both the interior display and the exterior camera to enable selective display of an output of the exterior camera on the interior display.

In at least some implementations, the exterior camera is mounted to the vehicle outside of the vehicle.

In at least some implementations, the exterior camera is mounted within the interior and the field of view includes at least one window via which the at least a portion of the area outside of the vehicle is within the field of view of the exterior camera.

In at least some implementations, the interior display is part of an infotainment system of the vehicle.

In at least some implementations, the system includes an exterior audio interface and an interior audio interface, wherein the exterior audio interface has a first audio output and a first audio input, wherein both the first audio output and the first audio input have a working range that includes at least a portion of an area outside of the vehicle, and wherein the interior audio interface has a second audio output and a second audio input, wherein both the second audio output and the second audio input have a working range that includes at least a portion of the interior, and wherein the first audio input is coupled to the second audio output and the first audio output is coupled to the second audio input to permit two-way audible communication between the interior and the at least a portion of the area outside of the vehicle.

In at least some implementations, the exterior display is movable relative to the vehicle, or a cover is provided and is movable relative to the exterior display, to enable selectively hiding and presentation of the exterior display.

In at least some implementations, the exterior display is mounted between a rearward most door of the vehicle and a rear end of the vehicle.

In at least some implementations, the system includes memory via which the output of the interior camera can be recorded. In at least some implementations, the system includes memory via which the output of the exterior camera can be recorded. In at least some implementations, the system includes memory via which audible sounds detected by the first audio input and the second audio input can be recorded. In at least some implementations, the interior camera is coupled to the memory so that the output from the interior camera can be recorded in the memory.

In at least some implementations, a vehicle communication system, includes an interior camera, and exterior display, an exterior camera, an exterior audio interface, an interior audio interface and a controller. The interior camera has a field of view that includes at least part of an interior of a vehicle. The exterior display is mounted within the interior or on an exterior of the vehicle and oriented for viewing by a person located outside of the vehicle. The interior display is arranged for viewing by an occupant of the vehicle. The exterior camera has a field of view that includes at least a portion of an area outside of the vehicle. The exterior audio interface has a first audio output and a first audio input, wherein both the first audio output and the first audio input have a working range that includes at least a portion of an area outside of the vehicle. The interior audio interface has a second audio output and a second audio input, wherein both the second audio output and the second audio input have a working range that includes at least a portion of the interior, and wherein the first audio input is coupled to the second audio output and the first audio output is coupled to the second audio input to permit two-way audible communication between the interior and the at least a portion of the area outside of the vehicle. And the controller is coupled to the interior camera and the exterior display to enable selective display of an output from the interior camera on the exterior display to enable said person to be able to view at least part of the interior. The controller is coupled to both the interior display and the exterior camera to enable selective display of an output of the exterior camera on the interior display. And the controller is coupled to both the interior audio interface and the exterior audio interface to selectively permit audible communication between the interior audio interface and the exterior audio interface.

In at least some implementations, the exterior camera is mounted to the vehicle outside of the vehicle, or the exterior camera is mounted within the interior and the field of view includes at least one window via which the at least a portion of the area outside of the vehicle is within the field of view of the exterior camera.

In at least some implementations, the exterior display is mounted to a body of the vehicle, and the exterior display is located between a rearward most door of the vehicle and a rear end of the vehicle.

In at least some implementations, the system includes memory via which one or more of the following can be recorded: a) the output of the interior camera; b) the output of the exterior camera; and c) audible sounds detected by the first audio input and the second audio input.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a front perspective view of a vehicle;

FIG. 2 is a rear view of the vehicle;

FIG. 3 is a perspective view of part of an interior of the vehicle;

FIG. 4 is a diagrammatic view of a system including a vehicle interior camera and an external display;

FIG. 5 is a fragmentary view of part of a vehicle body panel and an exterior display showing a front of the vehicle display;

FIG. 6 is a view similar to FIG. 5 and showing a rear side of the exterior display; and

FIG. 7 is a flowchart of a method of operating a display system of the vehicle.

### DETAILED DESCRIPTION

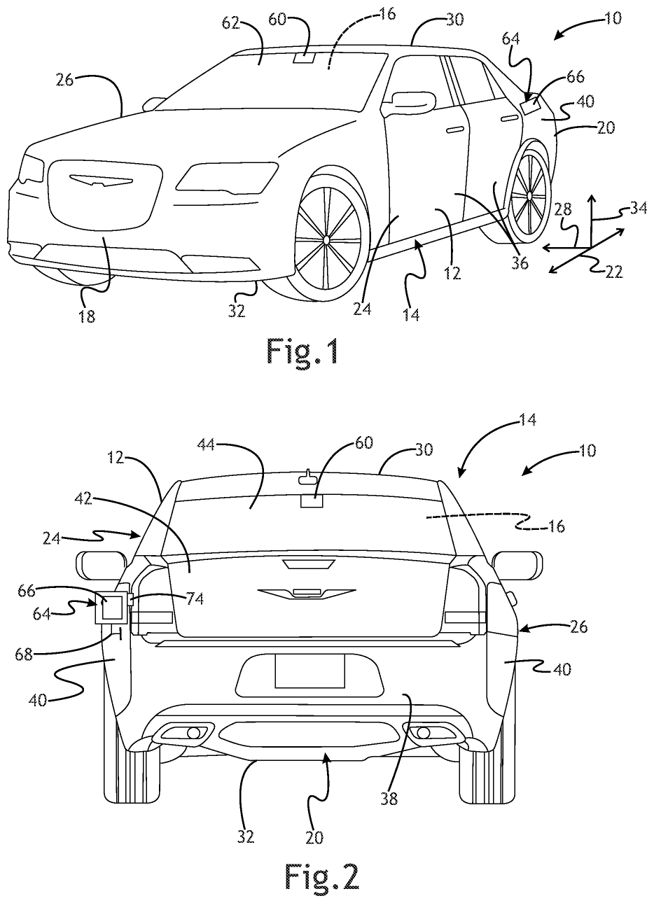

Referring in more detail to the drawings, this disclosure relates to a passenger vehicle 10 that has a body 12 defining a vehicle exterior 14 and an interior 16 of the vehicle 10 which includes a passenger compartment in which a driver and other occupants of the vehicle 10 are situated in use of the vehicle 10. The vehicle 10 includes a front end 18 and an opposite rear end 20 that are spaced apart in a fore-aft direction, which is shown by arrow 22 in FIG. 1, left and right sides 24, 26 that are spaced apart in a cross-car direction, which is shown by arrow 28 in FIG. 1, and a roof 30 spaced apart from a bottom 32 of the vehicle 10 in a vertical direction, which is shown by arrow 34 in FIG. 1. The vehicle 10 includes one or more doors 36 via which occupants can enter into or exit from the interior 12 of the vehicle 10.

FIGS. 1 and 2 illustrate part of the vehicle exterior 14, including a rear end 20 of the vehicle 10. The rear end 20 may include a rear bumper or fascia 38, part of rear quarter panels 40, a trunk lid 42, and a rear window 44. The rear window 44 may define a boundary of and provide a view into and out of the passenger compartment.

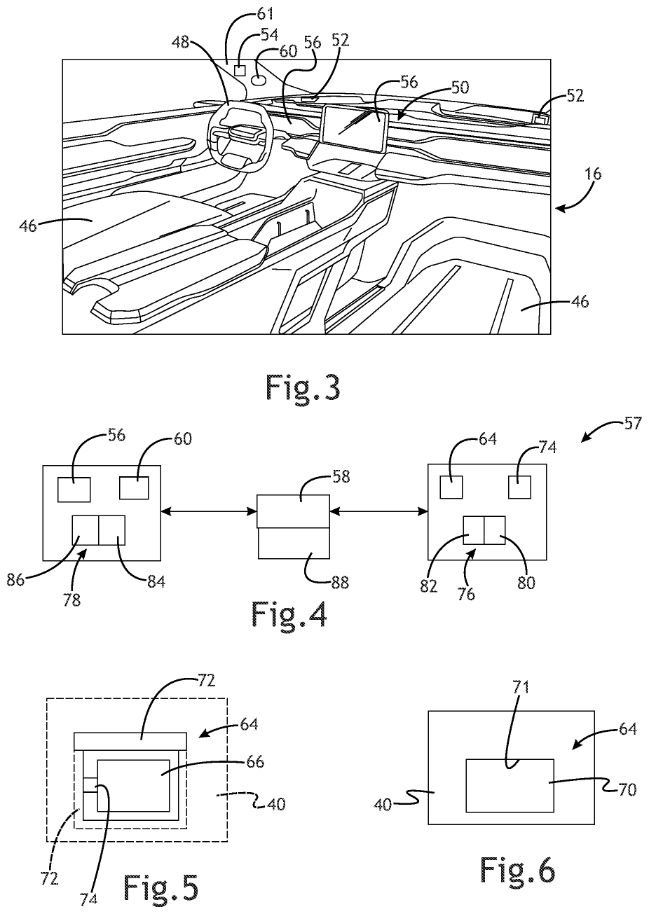

FIG. 3 illustrates the interior 16 of the vehicle 10 including part of the passenger compartment which includes one or more seats 46 or seating areas. One or more vehicle controls, such as a steering wheel 48, brake pedal and accelerator pedal, may be accessible from within the passenger compartment 16. Further, an infotainment system 50 including audio and visual devices, like speakers 52, microphones 54 and one or more display screens 56, may be accessible from within the passenger compartment.

As shown in FIG. 4, the vehicle 10 includes a communication system 57 that enables communication between people outside and inside the vehicle 10. The communication system 57 may include one or more visual displays to permit viewing of a person or area of interest and may include one or more audio devices to facilitate audio communication. A controller 58 or control system is connected to the communication devices and permits selective use or enablement of the devices.

In more detail, the vehicle 10 may include one or more interior camera 60 that may be mounted within the vehicle interior 16 and which may each have a field of view that includes at least part of the interior 16. In at least some implementations, at least one interior camera 60 is positioned so that its field of view is directed toward the front of a person sitting in a vehicle seat 46, such as a driver's seat 46 and/or front passenger seat 46. As shown in FIG. 2, an interior camera 60 may be mounted to an interior of the roof 30 and may provide an overhead, so-called birds-eye, view of most of the vehicle interior 16, and has a field of view that includes most or all of the vehicle seats 46/seating areas. As an example, an interior camera 60 could be mounted in an interior trim piece covering a pillar 61, as shown in FIG. 3, or near a housing for an overhead interior light (sometimes called a dome light), as shown in FIG. 2, or above and near a vehicle windshield 62 and facing toward the rear end 20 of the vehicle 10, as shown in FIG. 1. In this way, a single interior camera 60 may provide an output, such as an image or video feed, that shows every passenger in a vehicle 10, if desired. Other interior cameras 60 may be provided with different fields of view, as desired.

The communication system 57 also includes one or more exterior displays 64 (FIGS. 1, 2, 4), that may be mounted within the vehicle interior 16 or on or about a vehicle exterior 14. A single exterior display 64 will be discussed further for ease of description, but it is to be understood that more than one exterior display 64 may be provided. The exterior display 64 has a screen 66 that may be oriented for viewing by a person located outside of the vehicle 10, and may include any device capable of showing an image or video feed, such as display including LEDs, LCDs, OLEDs or the like. In at least some implementations, the exterior display 64 is mounted to the left or right side 24, 26 of the vehicle 10 or the rear end 20 of the vehicle 10 and may define part of an exterior surface of the vehicle 10 which may be collectively defined by each component of the vehicle 10 with a surface exposed at the vehicle exterior 14. In at least some implementations, the exterior display 64 is provided within the interior 16 of the vehicle 10 is in view through a window of the vehicle 10, such as but not limited to the rear window 44. In at least some implementations, the exterior display 64 is located behind a front seat 46 of the vehicle 10, that is, between the front seat 46 and the rear end 20 of the vehicle 10 in the fore-aft direction, so that a person viewing the exterior display 64 is behind the front seat 46 of the vehicle 10.

The exterior display 64 may be movable mounted to the vehicle 10 so that, in at least some implementations, the exterior display 64 may be moved from a first position, in which the screen 66 of the exterior display 64 is not directly viewable by a person outside the vehicle 10, such as is shown in FIG. 6, to a second position as shown in FIG. 5 in which the screen 66 of the exterior display 64 is directly viewable by a person outside the vehicle 10. By way of examples, the exterior display 64 may be pivoted to or slidable about a mount 68 that is fixed to the vehicle body 12 (where the body 12 may include the support structures/frame of the vehicle 10 as well as exterior body 12 panels, trim panels and the like). In at least some implementations, the screen 66 could be always viewable from the vehicle exterior 14, and the screen 66 may be movable relative to the vehicle 10 to change the viewing angle. In at least some implementations, the exterior display 64 is mounted between a rearward most door of the vehicle 10 (e.g. a vehicle 10 door closest to the rear end 20) and the rear end 20 of the vehicle 10.

In one example, a rear side 70 of the exterior display 64 may be oriented outwardly to be visible from the vehicle exterior 14 when the exterior display 64 is in the first position, as shown in FIG. 6, with the screen 66 oriented inwardly, facing away from vehicle exterior 14. In such an example, the rear side 70 may have a shape and color that is similar to or the same as an adjacent portion of the vehicle body 12 so that the presence of the exterior display 64 is not as easily detectable as it would be if the screen 66 were always exposed at the vehicle exterior 14. Further, in examples in which the exterior display 64 is received in a recess 71 of the vehicle body 12, the recess 71 may be attractively covered by the rear side 70 when the exterior display 64 is not being used. The exterior display 64 may be pivoted or rotated to selectively present the screen 66 or the rear side 70 of the exterior display 64 at the vehicle exterior 14.

In other examples, a cover 72 may be coupled to and movable relative to the vehicle 10 between a first position in which the cover 72 prevents viewing of the screen 66, as shown in dashed lines in FIG. 5, and a second position in which the cover 72 permits viewing of the screen 66, as shown in solid lines in FIG. 5. The cover 72 may have a shape and color that is similar to or the same as an adjacent portion of the vehicle body 12, so that a recess in which the exterior display 64 is mounted may be attractively covered when the exterior display 64 is not being used. In at least some implementations, the exterior display 64 is movable relative to the vehicle 10, or a cover 72 is provided and is movable relative to the exterior display 64, to enable selectively hiding and presentation of the exterior display 64.

To permit viewing of the output from an interior camera 60 on the exterior display 64, the interior camera 60 and exterior display 64 are communicated with each other. In at least some implementations, the system includes a controller 58 or control system that is coupled to the interior camera 60 and the exterior display 64, either via wired or wireless connection, to enable selective display of the output from an interior camera 60 on the exterior display 64. The controller 58 may be part of the infotainment system 50 or a different vehicle 10 system or a stand-alone device/system. The controller 58 may help to provide or control a human-machine interface of the infotainment system 50 or other vehicle 10 systems. In this way, the system may permit a user to selectively enable the exterior display 64 and/or permit the output from an interior camera 60 to be displayed on the exterior display 64. In at least some implementations, this may be done via menu options provided on an interior display 56 of the vehicle 10, which may be part of the infotainment system 50 or a separate display.

The interior display 56 may be arranged for viewing by an occupant of the vehicle 10, such as a driver of the vehicle 10, and may include a touchscreen interface or be associated with other inputs (e.g. buttons/switches) by which a user may select various menu options presented by the controller 58 or infotainment system 50. The output of one or more vehicle 10 cameras may be viewable via the interior display 56. For example, the vehicle 10 may include a camera in a rear bumper or fascia and/or at a front bumper or fascia, to assist in parking the vehicle 10, and/or to assist in object detection, lane keeping or some level of autonomous vehicle 10 control.

As shown in FIGS. 2, 4 and 5, the system may also include an exterior camera 74 having a field of view that includes at least a portion of an area outside of the vehicle 10. The exterior camera 74 may be mounted within the interior 16 of the vehicle 10 and have a window within its field of view, such as the rear window 44, via which the at least a portion of the area outside of the vehicle 10 is viewable, or the camera may be located outside of the interior such as by being mounted to a vehicle exterior 14 body 12. In at least some implementations, the exterior camera 74 is located on or within one foot from the exterior display 64, and the exterior camera 74 is arranged so that the face of a person viewing the exterior display 64 is within the field of view of the exterior camera 74. In at least some implementations, the controller 58 is coupled to both the interior display 56 and the exterior camera 74 to enable selective display of the output of the exterior camera 74 on the interior display 56. In this way, a vehicle occupant can see on the interior display 56 a person outside of the vehicle 10 who is viewing the exterior display 64, without the occupant having to turn around to directly view that person.

As described above, the system permits interior and/or exterior cameras 74 to be viewable from the vehicle exterior 14 and interior 16, respectively. In this way, a person outside the vehicle 10 can see the vehicle interior 16 including one or more occupants of the vehicle 10, and an occupant of the vehicle 10 can see a person outside the vehicle 10. As shown in FIG. 4, the system may also permit audio communication via one or both of an exterior audio interface 76 and an interior audio interface 78.

The exterior audio interface 76 has a first audio output 80, such as a speaker from which sounds are emitted, and a first audio input 82, such as a microphone via which sounds are transmitted. Both the first audio output 80 and the first audio input 82 may have a working range that includes at least a portion of an area outside of the vehicle 10 so that sounds may be emitted and picked up for transmission from such area outside the vehicle 10. This area may be an area from which the exterior display 64 is viewable so a person viewing the exterior display 64 can hear the audio output and have their spoken words or other sounds picked up by the microphone 82.

The interior audio interface 78 has a second audio output 84, such as a speaker from which sounds are emitted into the vehicle interior 16, and a second audio input 86 such as a microphone that picks up and transmits sounds audible within the interior. That is, both the second audio output 84 and the second audio input 86 may have a working range that includes at least a portion of the vehicle interior 16. The system may then communicate the first audio input 82 with the second audio output 84, and the first audio output 80 with the second audio input 86, to permit two-way audible communication between the vehicle interior 16 and at least a portion of the area outside of the vehicle 10. Via the audio interfaces 76, 78, a vehicle occupant can talk to a person outside the vehicle 10 who is within the working range of the exterior audio interface 76.

To enable recording of video and/or audio interactions between a vehicle occupant and a person outside the vehicle 10, the system may include memory 88 (FIG. 4) coupled to the output of one or more cameras and microphones. Recording of such interactions may be automatically started as soon as an interface is enabled, or a separate menu option/command may be provided to initiate a recording. The recording process or interfaces may be enabled by an occupant of the vehicle 10, as noted, or by a person outside of the vehicle 10 who may wirelessly connect with the system by a suitable interface, such as wifi, Bluetooth or the like, and suitable software permitting control of the system. The ability of a person outside the vehicle 10 to connect to and enable an interface may be an optional feature that can be turned on or off by a vehicle occupant or owner.

With the system described herein, interactions between, for example, a police office and one or more vehicle occupants can occur without requiring the police officer to get too close to an occupant within the vehicle 10. For example, the police officer could remain at or near the rear end 20 of the vehicle 10 and could see within the vehicle interior 16 and/or hear within the vehicle interior 16. Further, occupants of the vehicle 10 could see and/or hear the police officer without having to move around in the vehicle 10 or turn around to see the office which movement might alarm the police officer. The video and/or audio interfaces can thus make the interaction with a police officer less stressful and less dangerous for both the vehicle occupant(s) and the police officer. Information, such as vehicle registration, insurance and driver identification, could also be exchanged via the video and/or audio interfaces reducing or eliminating the need for direct contact/interaction between the police officer and the vehicle occupant(s). Such information could be captured by a camera, or could be previously input into the system and stored in one or more files (e.g. an image file or text file or both) that can be displayed on the exterior display 64 or elsewhere, or transmitted to a device via wired or wireless connection.

In order to perform the prescribed functions and desired processing, as well as the computations therefore (e.g., the identification of a pedestrian impact, control algorithm(s), and the like), the control system or one or more controllers 58 may include, but not be limited to, a processor(s), computer(s), DSP(s), memory 88, storage, register(s), timing, interrupt(s), communication interface(s), and input/output signal interfaces, and the like, as well as combinations comprising at least one of the foregoing. For example, controller 58 may include input signal processing and filtering to enable accurate sampling and conversion or acquisitions of such signals from sensors and communications interfaces.

As used herein the terms control system or controller 58 may refer to one or more processing circuits such as an application specific integrated circuit (ASIC), an electronic circuit, a processor (shared, dedicated, or group) and memory 88 that stores data/files and permits execution of one or more software or firmware programs, a combinational logic circuit, and/or other suitable components that provide the described functionality.

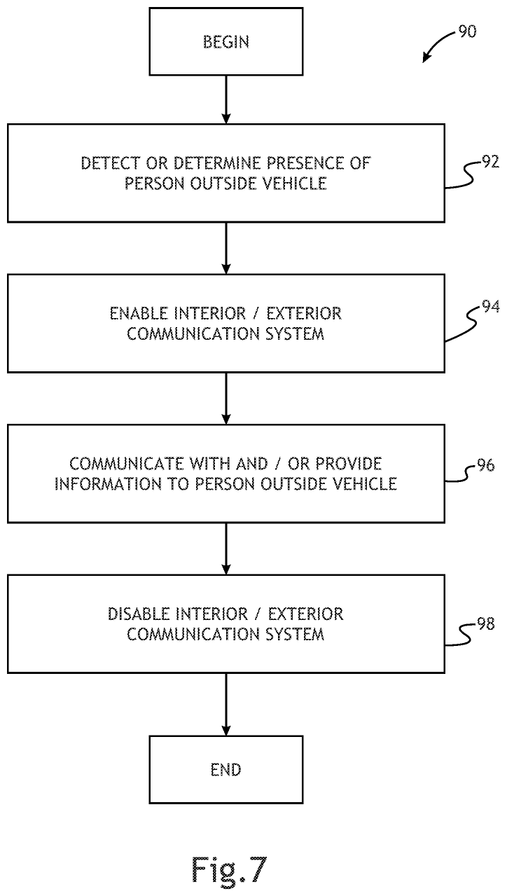

FIG. 7 illustrates a method 90 that may be employed in use of the interior/exterior communication system 57. In step 92, the method may include determining if a person, such as a police officer, is outside the vehicle 10 and/or is approaching the vehicle 10. This may be accomplished, for example, with image recognition techniques from the output from one or more cameras of the vehicle 10. This may instead be determined by the driver who visually sees the police officer or other person.

Next, in step 94, the system either automatically enables the interior/exterior communication system 57, or a vehicle occupant does so. When enabled, the cameras, displays and audio devices may be operational and recorded in the memory 88. If the system is not enabled, the police officer can approach a door/window of the vehicle 10 in the traditional manner, for a person-to-person interaction. In step 96, via the enabled system, a vehicle occupant can provide information to the exterior display 64 or to a remote device (e.g. by wireless transmission), for receipt and review by the police officer. Finally, in step 98, after an interaction has ended, the system may be disabled, such as by driver selection of a menu option to terminate use of the interior/exterior communication system 57.

With the ability to view and hear within a vehicle 10, a police officer will be better able to respond to various situations, and the officer need not interact face-to-face with a vehicle occupant for at least some of the interaction. Any perceived threatening action by the vehicle occupant can also be more clearly discerned by the police officer who, with space between him/her and the occupant, can seek cover or otherwise have more time to react to the situation than they would if standing immediately next to the occupant.

The vehicle occupant can also benefit by having space between them and an armed police officer. For example, the occupant reaching for documents or the like is less likely to be mistakenly viewed as a threatening action by the officer, due to the distance between them and the occupant, and the improved view of the vehicle interior 16 that can be provided by the one or more interior camera 60. In this way, the stress some people feel during interactions with police officers can be reduced. The stress can be further reduced when video and/or audio of the interaction is recorded, which tends to force people to behave appropriately.

Further, while situations involving police officers have been described, the interior/exterior communication system can be used with people and in situation not involving police officers. For example, to ensure the identity of a person before allowing the person to enter the vehicle or before exiting the vehicle with the person nearby, to converse with and view a stranger, to converse with a service person, and still other situations may benefit from the systems described herein.

1. A vehicle communication system, comprising:
an interior camera having a field of view that includes at least part of an interior of a vehicle;
an exterior display mounted within the interior or on an exterior of the vehicle and oriented for viewing by a person located outside of the vehicle; and
a controller coupled to the interior camera and the exterior display to enable selective display of an output from the interior camera on the exterior display to enable said person to be able to view at least part of the interior.

2. The system of claim 1 which also includes an interior display arranged for viewing by an occupant of the vehicle, and an exterior camera having a field of view that includes at least a portion of an area outside of the vehicle, and wherein the controller is coupled to both the interior display and the exterior camera to enable selective display of an output of the exterior camera on the interior display.

3. The system of claim 2 wherein the exterior camera is mounted to the vehicle outside of the vehicle.

4. The system of claim 2 wherein the exterior camera is mounted within the interior and the field of view includes at least one window via which the at least a portion of the area outside of the vehicle is within the field of view of the exterior camera.

5. The system of claim 2 wherein the interior display is part of an infotainment system of the vehicle.

6. The system of claim 1 which also includes an exterior audio interface and an interior audio interface, wherein the exterior audio interface has a first audio output and a first audio input, wherein both the first audio output and the first audio input have a working range that includes at least a portion of an area outside of the vehicle, and wherein the interior audio interface has a second audio output and a second audio input, wherein both the second audio output and the second audio input have a working range that includes at least a portion of the interior, and wherein the first audio input is coupled to the second audio output and the first audio output is coupled to the second audio input to permit two-way audible communication between the interior and the at least a portion of the area outside of the vehicle.

7. The system of claim 1 wherein the exterior display is movable relative to the vehicle, or a cover is provided and is movable relative to the exterior display, to enable selectively hiding and presentation of the exterior display.

8. The system of claim 1 wherein the exterior display is mounted between a rearward most door of the vehicle and a rear end of the vehicle.

9. The system of claim 1 which also includes memory via which the output of the interior camera can be recorded.

10. The system of claim 2 which also includes memory via which the output of the exterior camera can be recorded.

11. The system of claim 6 which also includes memory via which audible sounds detected by the first audio input and the second audio input can be recorded.

12. The system of claim 11 wherein the interior camera is coupled to the memory so that the output from the interior camera can be recorded in the memory.

13. A vehicle communication system, comprising:
an interior camera having a field of view that includes at least part of an interior of a vehicle;
an exterior display mounted within the interior or on an exterior of the vehicle and oriented for viewing by a person located outside of the vehicle;
an interior display arranged for viewing by an occupant of the vehicle;
an exterior camera having a field of view that includes at least a portion of an area outside of the vehicle;
an exterior audio interface having a first audio output and a first audio input, wherein both the first audio output and the first audio input have a working range that includes at least a portion of an area outside of the vehicle;
an interior audio interface having a second audio output and a second audio input, wherein both the second audio output and the second audio input have a working range that includes at least a portion of the interior, and wherein the first audio input is coupled to the second audio output and the first audio output is coupled to the second audio input to permit two-way audible communication between the interior and the at least a portion of the area outside of the vehicle; and
a controller coupled to the interior camera and the exterior display to enable selective display of an output from the interior camera on the exterior display to enable said person to be able to view at least part of the interior, and wherein the controller is coupled to both the interior display and the exterior camera to enable selective display of an output of the exterior camera on the interior display, and wherein the controller is coupled to both the interior audio interface and the exterior audio interface to selectively permit audible communication between the interior audio interface and the exterior audio interface.

14. The system of claim 13 wherein the exterior camera is mounted to the vehicle outside of the vehicle, or the exterior camera is mounted within the interior and the field of view includes at least one window via which the at least a portion of the area outside of the vehicle is within the field of view of the exterior camera.

15. The system of claim 13 wherein the exterior display is mounted to a body of the vehicle, and the exterior display is located between a rearward most door of the vehicle and a rear end of the vehicle.

16. The system of claim 1 which also includes memory via which one or more of the following can be recorded: a) the output of the interior camera; b) the output of the exterior camera; and c) audible sounds detected by the first audio input and the second audio input.
